(19) United States
(12) Patent Application Publication
(10) Pub. No.: US 2006/0044234 A1
(43) Pub. Date: Mar. 2, 2006

(54) Control of spectral content in a self-emissive display

(76) Inventor: Sumio Shimonishi, Inagi-City (JP)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/871,969

(22) Filed: Jun. 18, 2004

(51) Int. Cl. G09G 3/30

(52) U.S. Cl. 345/77; 345/207

(57) ABSTRACT

A self-emissive display may comprise a plurality of self-emissive pixel elements, a plurality of photosensors, and a control system. The photosensors are interspersed with the pixel elements to measure light that is emitted by the pixel elements. The control system is coupled to the photosensors and the pixel elements to 1) compare the light measurements to one or more spectral references, 2) set drive signal reference values in response to the comparisons, and 3) generate dynamic pixel element drive signals based on the reference values. A method for calibrating spectral content of a self-emissive display comprises causing at least some of a plurality of self-emissive pixel elements to produce light. The light is then measured and compared to one or more spectral references. In response to these comparisons, drive signal reference values are set. Dynamic pixel element drive signals are then generated based on the reference values.

### BACKGROUND

A common type of display that is used, for example, in applications such as computer systems, handheld electronics, signage and televisions is the liquid crystal display (LCD). LCDs are “transmissive” displays. That is, their pixel elements generate or filter color, but require a backlight to illuminate their color.

Plasma display panels (PDPs) and organic light emitting diode (OLED) displays differ from LCDs in that they are “self-emissive”. That is, their pixel elements not only generate color, but also illuminate their color. PDPs, OLEDs and other self-emissive display technologies are of interest in that the elimination of a backlight sometimes enables these displays to be manufactured thinner, and at lower cost. Self-emissive displays also typically provide a wider viewing angle than transmissive displays.

### SUMMARY OF THE INVENTION

In one embodiment, a self-emissive display comprises a plurality of self-emissive pixel elements, a plurality of photosensors, and a control system. The photosensors are interspersed with the pixel elements to measure light that is emitted by the pixel elements. The control system is coupled to the photosensors and the pixel elements to 1) compare the light measurements to one or more spectral references, 2) set drive signal reference values in response to the comparisons, and 3) generate dynamic pixel element drive signals based on the reference values.

In another embodiment, a method for calibrating spectral content of a self-emissive display comprises causing at least some of a plurality of self-emissive pixel elements to produce light. The light is then measured and compared to one or more spectral references. In response to these comparisons, drive signal reference values are set. Dynamic pixel element drive signals are then generated based on the reference values.

Other embodiments are also disclosed.

### BRIEF DESCRIPTION OF THE DRAWINGS

Illustrative and presently preferred embodiments of the invention are illustrated in the drawings, in which:

FIG. 1 illustrates an exemplary front view of pixel elements, sensing means and control means for controlling spectral content in a self-emissive display;

FIG. 2 illustrates a side view of the apparatus shown in FIG. 1; and

FIG. 3 illustrates an exemplary method for calibrating spectral content of a self-emissive display.

### DETAILED DESCRIPTION OF AN EMBODIMENT

Unlike transmissive displays (e.g., LCDS), the pixel elements of self-emissive displays (e.g., OLED displays and PDPs) are capable of generating both color and illumination. Often, a plurality (or set) of pixel elements will be used to define the color of a single image pixel (i.e., a point in a displayed image). Typically, a set of pixel elements will take the form of red, green and blue (RGB) pixel elements.

During manufacture or test, the pixel elements of a self-emissive display may be calibrated so that, when programmed with the same color information, like-colored pixel elements generate the same color and intensity of color. In the case of an RGB set of pixel elements, the color produced by such a set may be varied by altering the ratios of intensities produced by the set's individual pixel elements; and the intensity of color produced by such a set may be varied by increasing or decreasing the intensities of all of the pixel elements in the set. The intensities of the pixel elements are adjusted by varying one or more drive signals of the pixel elements. Typically, these drive signals take the form of a current or voltage that is applied to each pixel element, or to groups of the pixel elements.

As a result of aging, environmental conditions (e.g., temperature), and manufacturing tolerances, the color(s) and intensities of the pixel elements in a self-emissive display can drift. Without a means to compensate for these drifts, a user may become dissatisfied with the display's images.

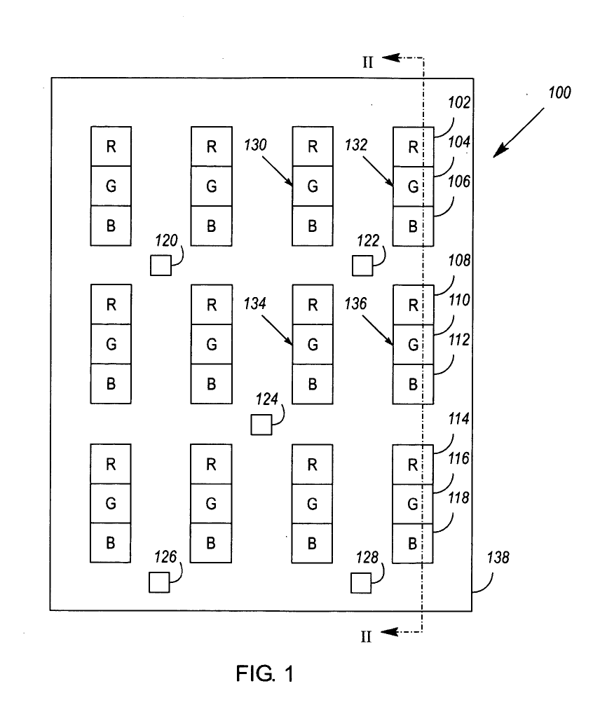

FIGS. 1 & 2 illustrate a self-emissive display 100 comprising a plurality of self-emissive pixel elements (e.g., elements 102-118). By way of example, the pixel elements 102-118 are shown to comprise red (R), green (G) and blue (B) pixel elements, grouped into RGB sets. During normal operation of the display 100, the pixel elements 102-106 of an RGB set are programmed to produce various intensities of light that meld together to produce the color of a single image pixel (i.e., a single point in a displayed image). In alternate embodiments, the color of an image pixel might be produced by more or fewer pixel elements. For example, in a monochrome display, a single pixel element could dictate the color of a single image pixel.

The number of pixel elements 102-118 shown in FIGS. 1 & 2 is representative only, and an actual display 100 will likely comprise thousands or even millions of pixel elements. Also, the construction and orientation of the pixel elements 102-118 shown in FIGS. 1 & 2 is merely representative, and actual pixel elements may be variously configured, depending on the type of self-emissive display of which they form a part (e.g., PDP or OLED display).

The display 100 further comprises a sensing means 120, 122, 124, 126, 128 and a control means 200. The sensing means 120-128 is provided for measuring light that is emitted by the pixel elements 102-118, while the control means 200 is provided for 1) comparing the light measurements to one or more spectral references, 2) setting drive signal reference values in response to the comparisons, and then 3) generating dynamic pixel element drive signals based on the reference values.

By way of example, the sensing means 120-128 may comprise a plurality of photosensors, such as photodiodes, that measure light intensities. In one embodiment, at least some of the photosensors 120-128 are interspersed among the pixel elements 102-118 so as to measure light that is output by one or more of the pixel elements. For example, FIG. 1 shows some photosensors (e.g., photosensor 122) to be positioned between four sets 130, 132, 134, 136 of RGB pixel elements.

One way to measure light produced by the RGB pixel elements shown in FIG. 1 is to drive only the red pixel elements 102, 108, 114, and then cause the sensing means 120-128 to measure the light output therefrom. If a photosensor is provided for each pixel element (or RGB set of pixel elements), the light measured by the photosensor may then be used to set a drive signal reference value for its corresponding red pixel element. If, on the other hand, a photosensor 122 is positioned adjacent a group of pixel elements 130-136, as shown in FIG. 1, its light measurement may be used to set a drive signal reference value (or values) for each of the red pixel elements it is configured to sense. Alternately, the light measurements of various photosensors effected by a given red pixel element may be combined. In this manner, the light measurements of a plurality of photosensors may be used to estimate the light output of a single red pixel element.

After measuring the light produced by red pixel elements 102, 108, 114 (or any other color of pixel elements), the light produced by other colors of pixel elements (e.g., green 104, 110, 116 and blue 106, 112, 118) may be measured in a similar manner.

Another way to measure light produced by the RGB pixel elements 130-136 shown in FIG. 1 is to replace each photosensor 120-128 with two or more photosensors, each of which comprises a filter so that it measures only a predetermined color (or color range) of light. In this manner, it is possible to drive all pixel elements 102-118 at the same time, and take all light measurements at the same time. Note that, to provide the greatest control over individual pixel elements 102-118, a group of filtered photosensors could be associated with each set of RGB pixel elements 130-136. Alternately, to save cost, photosensors could be implemented less frequently than what is shown in FIG. 1. However, the fewer the number of photosensors, the less control the self-emissive display 100 has over the light produced by individual ones of its pixel elements 102-118.

In one embodiment of the display 100, light measurements are made via photodiodes 120-128, the currents of which are converted to voltages and then digitized.

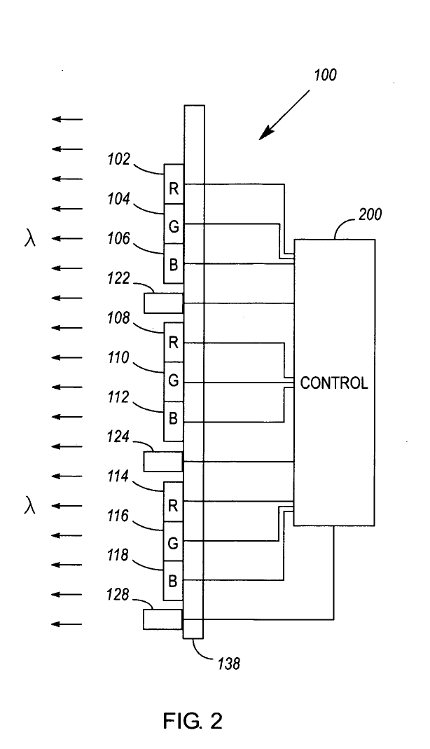

The control means 200 (FIG. 2) may take the form of a hardware, firmware and/or software-based control system. In one embodiment of the control system 200, a spectral reference is maintained for each of a number of light colors (or wavelengths) such as red, green and blue light. Measurements of different colored light are then compared to their corresponding spectral references. By way of example, each spectral reference may take the form of a digital value. These digital values may be hard-wired, burned into a memory, or programmed by software or firmware. In one embodiment, spectral references are derived from user input to the display 100, or to a computer attached thereto (e.g., by means of the user setting a color temperature for the display). Comparison of a light measurement to its corresponding spectral reference provides an indication of whether the spectral content produced by one or more pixel elements 102-118 is in range.

The control means 200 may also store drive signal reference values for one or more (and preferably all) of the pixel elements 102-118 in a display. These drive signal reference values are baselines from which dynamic pixel element drive signals are generated. In other words, drive signal reference values are indicative of the drive signals that cause a plurality of pixel elements 102-106 to produce a predetermined spectral content. However, given that most displays 100 are dynamic in nature (i.e., their displayed text or images change over time), their pixel elements will necessarily need to produce a varying spectral content. This varying spectral content is produced by generating dynamic pixel element drive signals in response to the drive signal reference values. In this manner, the spectral content of a display's pixel elements 102-118 is related to a baseline that is derived, at least in part, from the measured spectral content of the display's pixel elements 102-118. When measurements of the display's spectral content show the display's spectral content to be out of range, the drive signal reference values are set to new values, with an expectation that the new values will bring the display's spectral content within range.

The most control over a display's spectral content is obtained when the control means 200 sets different drive signal reference values for each of a display's pixel elements 102-118. There may be times, however, when the spectral content of a pixel element has deteriorated to such a point that it is impossible to generate a drive signal that will bring the element's spectral content within range.

In one embodiment, the control means 200 acquires light measurements from the sensing means 120-128, and performs light measurement comparisons and reference value setting, during a configuration mode of the display 100. Dynamic drive signal generation may then be undertaken during normal operation of the display 100. The configuration mode may be triggered in a variety of ways. For example, the display 100 may comprise a power switch that, when activated, initiates the configuration mode prior to normal operation of the display 100. Alternately (or additionally), the display may comprise an I/O port to connect the display 100 to a computer system, and receipt of a predetermined command through the display's I/O port may initiate the configuration mode.

In another embodiment, light measurements may be taken and reference values may be set during normal operation of the display 100. In this embodiment, some or all of a display's pixel elements 102-118 may periodically and temporarily display a predetermined spectral content that can be measured for evaluation by the display's control means 200. However, while feasible, such an embodiment may at times result in screen flicker.

In FIGS. 1 & 2, the display's pixel elements 102-118 and sensing means 120-128 are shown to be mounted on a common substrate 138. However, they need not be. In one embodiment, the substrate 138 is used to provide interconnections between the display's pixel elements 102-118, sensing means (e.g., photosensors 120-128), and control means 200. Also note that the control means 200 need not be a centralized control system (e.g., a separate integrated circuit or circuits), and elements of the control means 200 could, for example, be interspersed with the pixel elements 102-118.

It should be noted that, in addition to being used “in the field” to calibrate the spectral content of a display's pixel elements 102-118, the sensing and control means 120-128, 200 disclosed herein can also be used during initial display calibration (e.g., during manufacture and test).

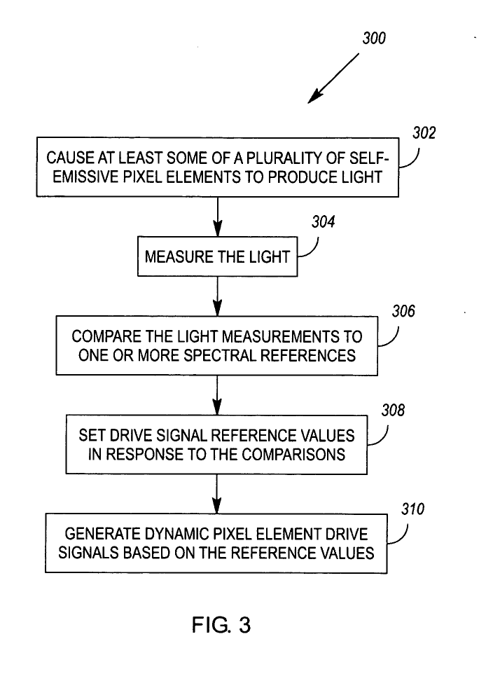

FIG. 3 illustrates an exemplary method 300 for calibrating spectral content of a self-emissive display. By way of example, the method 300 could be performed by the apparatus 100 shown in FIGS. 1 & 2. In accordance with the method 300, at least some of a plurality of self-emissive pixel elements are caused 302 to produce light. Their light is then measured 304, and compared 306 to one or more spectral references. Thereafter, drive signal reference values are set 308 in response to the comparisons, and dynamic pixel element drive signals are generated 310 based on the reference values. Preferably, the method's actions are performed automatically, such that no user input is required for the display to calibrate itself.

In one embodiment of the method 300, the display's pixel elements comprise pixel elements of two or more colors, and the pixel elements are caused to produce light by color group, with light measurements being taken for each color group. By way of example, the pixel elements may be caused to produce light by color group upon boot of a computer that is attached to the display, or upon powering of the display. The pixel elements may also be caused to produce light by color group during a configuration mode, with dynamic pixel element drive signals then being generated during normal operation of the display.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A self-emissive display, comprising:
a plurality of self-emissive pixel elements;
a plurality of photosensors, interspersed with the pixel elements to measure light emitted by the pixel elements; and
a control system, coupled to the photosensors and the pixel elements, to compare said light measurements to one or more spectral references, to set drive signal reference values in response to said comparisons, and to generate dynamic pixel element drive signals based on said reference values.

2. The display of claim 1, wherein the self-emissive pixel elements comprise plasma display panel pixel elements.

3. The display of claim 1, wherein the self-emissive pixel elements comprise organic light emitting diode pixel elements.

4. The display of claim 1, wherein the photosensors comprise photodiodes.

5. The display of claim 1, wherein the photosensors have a one-to-one correspondence with the pixel elements.

6. The display of claim 1, wherein at least some photosensors are positioned to measure light from a group of pixel elements.

7. The display of claim 6, wherein the group of pixel elements comprises corresponding red, green and blue pixel elements.

8. The display of claim 6, wherein the group of pixel elements comprises a plurality of like-colored pixel elements.

9. The display of claim 1, wherein different photosensors are configured to measure different colors of light, and wherein the control system compares measurements of different colored light with different spectral references.

10. The display of claim 1, wherein said light measurements are light intensity measurements.

11. The display of claim 1, wherein i) the control system acquires said light measurements from said photosensors, and performs said comparison and setting actions, during a configuration mode of the self-emissive display, and ii) performs said dynamic drive signal generation during normal operation of the self-emissive display.

12. The display of claim 11, further comprising a power switch that, when activated, initiates said configuration mode prior to normal operation of the display.

13. The display of claim 11, further comprising an I/O port to connect the display to a computer system, wherein receipt of a predetermined command through the display's I/0 port initiates said configuration mode.

14. A self-emissive display, comprising:
a plurality of self-emissive pixel elements;
sensing means for measuring light emitted by the pixel elements; and
control means for comparing said light measurements to one or more spectral references, setting drive signal reference values in response to said comparisons, and generating dynamic pixel element drive signals based on said reference values.

15. A method for calibrating spectral content of a self-emissive display, comprising:
causing at least some of a plurality of self-emissive pixel elements to produce light;
measuring the light;
comparing said light measurements to one or more spectral references;
setting drive signal reference values in response to said comparisons;
generating dynamic pixel element drive signals based on said reference values.

16. The method of claim 15, wherein:
said pixel elements comprise pixel elements of two or more colors; and
said pixel elements are caused to produce light by color group, with light measurements being taken for each color group.

17. The method of claim 16, wherein said pixel elements are caused to produce light by color group upon boot of a computer that is attached to said display.

18. The method of claim 16, wherein said pixel elements are caused to produce light by color group upon powering of the display.

19. The method of claim 16, wherein said pixel elements are caused to produce light by color group during a configuration mode, and wherein said dynamic pixel element drive signals are generated during normal operation of the display.

20. The method of claim 15, wherein the actions of the method are automatically performed by the display.
